(19) United States
(12) Patent Application Publication
(10) Pub. No.: US 2022/0025692 A1
(43) Pub. Date: Jan. 27, 2022

(54) POWER ACTUATOR UNIT FOR POWERED DOOR HAVING A MECHANICALLY ACTUATED CLUTCH/BRAKE ASSEMBLY

(71) Applicant: MAGNA CLOSURES INC., Newmarket (CA)

(72) Inventors: Arthur J.W. HENES, Newmarket (CA); John G. ZEABARI, Newmarket (CA)

(21) Appl. No.: 17/374,708

(22) Filed: Jul. 13, 2021

Related U.S. Application Data
(60) Provisional application No. 63/057,220, filed on Jul. 27, 2020.
(60) Provisional application No. 63/194,646, filed on May 28, 2021.

(51) Int. Cl. E05F 15/622; E05F 15/614

(52) U.S. Cl. CPC E05F 15/622; E05F 15/614; E05Y 2900/531; E05Y 2201/702; E05Y 2201/216; E05Y 2201/434

(57) ABSTRACT

A power drive mechanism includes an electric motor configured to rotate a drive member, a housing having an inner wall bounding a cavity, and an extensible actuation member linearly moveable in a first direction to move a vehicle swing door in an opening direction and in a second direction to move the vehicle swing door in a closing direction. A clutch/brake assembly is disposed in the cavity of the housing. The clutch/brake assembly operably connects the drive member with the extensible actuation member. The clutch/brake assembly is moveable from a disengaged state, whereat the extensible actuation member is inhibited from moving relative to the housing, to an engaged state, whereat the extensible actuation member moves relative to the housing. The clutch/brake assembly moves mechanically from the engaged state to the disengaged state in response to the electric motor changing from the energized state to the de-energized state.

### CROSS-REFERENCE TO RELATED APPLICATIONS

This utility application claims the benefit of U.S. Provisional Application No. 63/057,220 filed Jul. 27, 2020 and U.S. Provisional Application No. 63/194,646 filed May 28, 2021. The entire disclosures of the above applications are incorporated herein by reference.

### FIELD

The present disclosure relates generally to power door systems for motor vehicles and, more particularly, to power actuator units and power door systems operable for moving a vehicle swing door relative to a vehicle body between an open position and a closed position.

### BACKGROUND

This section provides background information related to the present disclosure which is not necessarily prior art.

The passenger doors on motor vehicles are typically mounted by upper and lower door hinges to the vehicle body for swinging movement about a generally vertical pivot axis. Each door hinge typically includes a door hinge strap connected to the passenger door, a body hinge strap connected to a pillar (e.g., A and B pillar) of the vehicle body, and a pivot pin arranged to pivotably connect the door hinge strap to the body hinge strap and define the vertical pivot axis. Such swinging passenger doors (“swing doors”) have recognized issues such as, for example, when the vehicle is situated on an inclined surface and the swing door either opens too far or swings shut due to the unbalanced weight of the swing door. To address this issue, most passenger swing doors have some type of detent or check mechanism integrated into at least one of the door hinges that functions to inhibit uncontrolled swinging movement of the swing door by positively locating and holding the swing door in one or more mid-travel positions in addition to a fully-open position. In some high-end vehicles, the door hinge may include an electronically controlled, infinite door check mechanism which allows the swing door to be opened and held in check at any desired open position. One advantage of passenger swing doors equipped with door hinges having an infinite door check mechanism is that the swing door can be located and held in any position to avoid contact with adjacent vehicles or structures.

As a further advancement, power door actuation systems have been developed which function to automatically swing the passenger swing door about its vertical pivot axis between the open and closed positions. Typically, power door actuation systems include a power actuator unit including, such as, for example, an electric motor and a rotary-to-linear conversion device that are operable for converting the rotary output of the electric motor into translational movement of an extensible member. In most arrangements, the electric motor and the rotary-to-linear conversion device are mounted within an internal cavity of the passenger swing door and the distal end of the extensible member is fixedly secured to the associated pillar (e.g., A and B pillar) of the vehicle body. For example, the power actuator unit can have a rotary-to-linear conversion device configured to include an externally-threaded leadscrew rotatably driven by the electric motor and an internally-threaded drive nut meshingly engaged with the leadscrew and to which a tubular extensible member is attached. Accordingly, electronic control over the speed and direction of rotation of the leadscrew results in control over the speed and direction of translational movement of the drive nut and the tubular extensible member for controlling swinging movement of the passenger swing door between its open and closed positions.

While such power actuation units generally function satisfactorily for their intended purpose, one recognized drawback relates to their ability to regulate coupled driving and back-driving interaction between the motor and the rotary-to-linear conversion device in economical fashion. Known coupling mechanisms are generally electronically controlled or otherwise complex, which although generally effective, are expensive in manufacture and assembly.

The power actuator unit may also be used to act as the infinite door check mechanism in which the door is maintained in a partially open position by the power actuator unit. Using the power actuator to provide such an infinite door check mechanism can eliminate the need for an electromechanical brake (e.g., reduces costs). However, one drawback to using the power actuator unit for the infinite door check is the constant power draw needed to use the power actuator unit as a brake mechanism. If the door is left in the partially open position for an extended period of time, the battery of the vehicle powering the power actuator unit may drain completely.

In view of the above, there remains a need to develop alternative power door actuation systems, which address and overcome drawbacks associated with known power door actuation systems, as well as to provide increased operating efficiency and applicability while reducing cost and complexity of the power door actuation system, in manufacture, assembly and in use.

### SUMMARY

This section provides a general summary of the present disclosure and is not intended to be a comprehensive disclosure of its full scope or to represent all of its features, aspects and objectives, which will be apparent to one possessing ordinary skill in the associated art.

According to an aspect of the present disclosure there is provided a power drive mechanism and power actuator unit which is operable for moving a vehicle swing door between open and closed positions relative to a ‘vehicle body that overcomes the drawbacks of known power drive mechanisms and power actuator units.

According to another aspect of the present disclosure there is provided a power actuator unit which is operable for moving a vehicle swing door between open and closed positions relative to a vehicle body that includes a purely mechanically actuated clutch/brake assembly that overcomes the drawbacks of known complex electromechanical clutch/brake assemblies.

According to another aspect of the present disclosure there is provided a power actuator unit which is operable for moving a vehicle swing door between open and closed positions relative to a vehicle body that includes a purely mechanically actuated clutch/brake assembly that, while at rest in a deactivated state, prevents back-driving of a rotary-to-linear conversion device to hold the vehicle swing door in a temporarily fixed, open position.

According to another aspect of the present disclosure there is provided a power actuator unit which is operable for moving a vehicle swing door between open and closed positions relative to a vehicle body that includes a purely mechanically actuated clutch/brake assembly that, while driven mechanically to an activated state, allows the motor to drive the rotary-to-linear conversion device to move the vehicle swing door between its open and closed positions.

In accordance with these and other aspects, the power swing door actuator unit of the present disclosure is configured for use in power drive mechanism in a motor vehicle having a vehicle body defining a door opening and a swing door pivotably connected to the vehicle body for movement about a pivot axis along a swing path between open and closed positions. The power drive mechanism includes an electric motor having a de-energized state and an energized state; a housing having an inner wall bounding a cavity, and an extensible actuation member linearly moveable relative to the housing, wherein linear movement of the extensible actuation member in a first direction causes movement of the vehicle swing door in an opening direction from the closed position toward the open position and linear movement of the extensible actuation member in a second direction causes movement of the vehicle swing door in a closing direction from the open position toward the closed position. Further, a clutch and brake assembly is disposed in the cavity of the housing. The clutch and brake assembly operably connects the drive member to the extensible actuation member and is moveable from a disengaged state, whereat the extensible actuation member is inhibited from moving relative to the housing, to an engaged state, whereat the extensible actuation member moves relative to the housing. The clutch and brake assembly moves from the disengaged state to the engaged state in response to the electric motor being switched from the de-energized state to the energized state.

In accordance with another aspect, the clutch and brake assembly moves in purely mechanical fashion from the engaged state to the disengaged state in response to the electric motor being switched from the energized state to the de-energized state.

In accordance with another aspect, the clutch and brake assembly includes a spring member disposed in the cavity of the housing. The spring member is biased to a radially expanded state, whereat the spring member is in locked engagement with the inner wall of the housing, when the electric motor is in the de-energized state, whereat the extensible actuation member is inhibited from moving in the second direction to inhibit the vehicle swing door from moving from the open position toward the closed position.

In accordance with another aspect, the spring member is wound against the bias to a radially contracted state into operable engagement with a driven member operably coupled to the extensible actuation member, whereat the spring member is spaced radially inwardly in clearance relation from the inner wall, when the electric motor is in the energized state, whereat the extensible actuation member is driven in the first direction to move the vehicle swing door from the closed position toward the open position.

In accordance with another aspect, while the vehicle swing door is in the open position and while the electric motor is in the de-energized state, movement of the extensible actuation member in the second direction causes the driven member, operably coupled to the extensible actuation member, to engage the spring member and increase the bias of the spring member toward the radially expanded state to increase locked engagement of the spring member with the inner wall to inhibit the vehicle swing door from moving in the closing direction toward the closed position.

In accordance with another aspect, the clutch and brake assembly includes a drive member having a generally cylindrical outer wall region, wherein the spring member is disposed about the generally cylindrical outer wall region in radially spaced relation therefrom while in the radially expanded state and in radially constricted engagement therewith while in the radially contracted state.

In accordance with another aspect, the spring member can be provided as a coil spring, having opposite ends configured for operable engagement with the drive member and the driven member.

In accordance with another aspect, the drive member can be provided as a clutch plate operably fixed to an output member of the electric motor and the driven member can be provided as a fork operably fixed to an input member coupled to the extensible actuation member, with the fork being driven by the spring member in response to the spring member being radially constricted by the clutch plate, whereat the extensible actuation member is driven in the first direction by the input member.

In accordance with another aspect, the input member can be provided as a worm gear configured in meshed engagement with a leadscrew of the extensible actuation member.

In accordance with another aspect, a method of operating a power-operated door system and inhibiting inadvertent movement of a vehicle swing door from an open position toward a closed position is provided. The method includes providing an electric motor having a de-energized state and an energized state; providing an extensible actuation member that is linearly moveable in a first direction to cause movement of the vehicle swing door in an opening direction and in a second direction to cause movement of the vehicle swing door in a closing direction; providing a clutch and brake assembly operably connecting the electric motor with the extensible actuation member, and configuring the clutch and brake assembly to move the extensible actuation member in the first direction while the clutch and brake assembly is in an engaged state and to inhibit the extensible actuation member from moving in the second direction while the clutch and brake assembly is in a disengaged state; and configuring the clutch and brake assembly to become mechanically actuated and move to the disengaged state when the electric motor is changed from the energized state to the de-energized state.

In accordance with another aspect, a method of operating a clutch and brake assembly coupling a rotatable input with a rotatable output is provided. The clutch and brake assembly includes a spring member disposed in a cavity of a housing. The spring member is biased to a radially expanded state in locked engagement with an inner wall of the housing. The method includes a step of rotating the rotatable input to cause the spring member to radially constrict and transition the spring member from a locked engagement with the inner wall to an unlocked engagement from the inner wall to allow the rotatable output to rotate conjointly in conjunction with the rotatable input. The method further includes a step of stopping the rotating of the rotatable input to cause the spring member to return to the radially expanded state and transition the spring member from the unlocked engagement to the locked engagement with the inner wall to prevent rotation of the rotatable output relative to the housing.

In accordance with another aspect, the step of rotating the rotatable input can be performed by a step of energizing an electric motor and the step of stopping the rotating of the rotatable input can be performed by a step of de-energizing the electric motor.

According to another aspect of the present disclosure there is provided a power door system. The power door system includes an electric motor for operating an extensible actuation member to move a door between open and closed positions. The power door system additionally includes a brake mechanism adapted to apply a braking force to the extensible actuation member for resisting motion of the door. The power door system also includes an electronic control module for controlling the electric motor in a power assist mode in response to a detected motion of the door by a user moving the door to overcome the braking force. The brake mechanism is operable in a slip state to allow the door to be moved by the user in order for the electronic control module to detect the detected motion to activate the power assist mode of the electronic control module.

According to yet another aspect of the present disclosure there is provided a power door system. The power door system includes an electric motor producing a motor force for operating an extensible actuation member to move a door between open and closed positions. The power door system also includes a brake mechanism adapted to apply a braking force to the extensible actuation member for resisting motion of the door. The brake mechanism is configured to apply a friction force during motion of the door and while the door is not in motion. In addition, the power door system includes an electronic control module for controlling the electric motor. The electronic control module is configured to move the door by controlling the motor force to negate the braking force during the motion of the door.

In accordance with another aspect, the brake mechanism is a constant friction device including a contact ring coupled to a motor shaft of the electric motor and engaging a sprag ring. The contact ring abuts a wave spring compressed against the electric motor for applying the braking force in a constant manner to resist rotation of the motor shaft.

In accordance with another aspect, the sprag ring includes a plurality of equally-spaced drive lugs and the contact ring includes a rim segment including a plurality of anti-rotation features arranged and configured to each accept and retain a corresponding one of the plurality of equally-spaced drive lugs of the sprag ring to prevent relative rotational motion between the contact ring and the sprag ring while permitting relative axial movement therebetween. The rim segment of the contact ring has an inner surface sized and configured to engage an outer surface of motor shaft. The contact ring includes a radial pressure plate segment extending radially outwardly from rim segment and having an annular engagement flange extending axially outwardly from rim segment to define a friction contact surface to abut the wave spring.

In accordance with another aspect, the brake mechanism is a clutch and brake assembly for applying a friction resistance against a manual door motion input in an engaged state and removing the friction resistance in a disengaged state.

According to another aspect of the present disclosure there is provided a method of operating a power closure member actuation system. The method includes the step of configuring a power actuator to have a clutch and brake assembly for applying a friction resistance against a manual door motion input in an engaged state and removing the friction resistance in a disengaged state. The method also includes the step of detecting motion of a door by a user when the clutch and brake assembly is in a slip state. The method proceeds with the step of configuring an electronic control module for controlling an electric motor of the power actuator to move the door in response to detecting motion of the door. The control of the electric motor causes the clutch and brake assembly to shift from the engaged state to the disengaged state.

According to an additional aspect of the present disclosure there is provided a method of operating a power door system. The method includes the step of configuring a power actuator to have a constant friction device for applying a constant friction resistance against a manual door motion input. The method also includes the step of detecting by an electronic control module motion of a door from a user and in response controlling the power actuator to move the door to assist the user with moving the door. The method continues by configuring the electronic control module for controlling the power actuator to compensate for the friction of the constant friction device for moving the door, such that the user does not have to overcome the constant friction resistance.

According to an additional aspect of the present disclosure there is provided a method of operating a power closure member actuation system. The method includes the step of configuring a power actuator to have a brake mechanism adapted to apply a braking force to an extensible actuation member of the power actuator for resisting motion of a door. The method continues by detecting motion of the door by a user. The method proceeds with the step of controlling an electric motor in a power assist mode using an electronic control module in response to a detected motion of the door by the user moving the door to overcome the braking force, wherein the brake mechanism is operable in a slip state to allow the door to be moved by the user in order for the electronic control module to detect the detected motion to activate the power assist mode of the electronic control module.

In accordance with another aspect, the brake mechanism is a clutch and brake assembly for applying a friction resistance against a manual door motion input in an engaged state and removing the friction resistance in a disengaged state. The method further includes the step of detecting motion of the door by the user when the clutch and brake assembly is in a slip state. The next step of the method is configuring the electronic control module for controlling the electric motor of the power actuator to move the door in response to detecting motion of the door. The control of the electric motor causes the clutch and brake assembly to shift from the engaged state to the disengaged state.

In accordance with another aspect, the brake mechanism is a clutch and brake assembly and the power actuator includes an electric motor operably connected to the extensible actuation member. The electric motor has a de-energized state and an energized state. The extensible actuation member is linearly moveable in a first direction to cause movement of the door in an opening direction and in a second direction to cause movement of the door in a closing direction. The method further includes the step of configuring the clutch and brake assembly to move the extensible actuation member in the first direction while the clutch and brake assembly is in an engaged state and to inhibit the extensible actuation member from moving in the second direction while the clutch and brake assembly is in a disengaged state. The method also includes the step of configuring the clutch and brake assembly to become mechanically actuated and move to the disengaged state when the electric motor is changed from the energized state to the de-energized state.

In accordance with another aspect, the clutch and brake assembly couples a rotatable input with a rotatable output and includes a spring member disposed in a cavity of a housing. The spring member is biased to a radially expanded state in locked engagement with an inner wall of the housing. The method further includes the step of rotating the rotatable input to cause the spring member to radially constrict and transition the spring member from a locked engagement with the inner wall to an unlocked engagement from the inner wall to allow the rotatable output to rotate conjointly in conjunction with the rotatable input. The method additionally includes the step of stopping the rotating of the rotatable input to cause the spring member to return to the radially expanded state and transition the spring member from the unlocked engagement to the locked engagement with the inner wall to prevent rotation of the rotatable output relative to the housing.

In accordance with another aspect, the step of rotating the rotatable input can include the step of energizing the electric motor and the step of stopping the rotating of the rotatable input can include the step of de-energizing the electric motor.

In accordance with another aspect, the brake mechanism is a constant friction device for applying a constant friction resistance against a manual door motion input. The method further includes the steps of detecting by the electronic control module motion of the door from the user and in response controlling the power actuator to move the door to assist the user with moving the door. The method also includes the step of configuring the electronic control module for controlling the power actuator to compensate for the constant friction resistance of the constant friction device for moving the door such that the user does not have to overcome the constant friction resistance.

In accordance with another aspect there is provided a power door system comprising an electric motor for operating an extensible actuation member to move a door between open and closed positions, a brake mechanism adapted to apply a braking force to the extensible actuation member for resisting motion of the door, and an electronic control module for controlling the electric motor to output a force to move the door and to overcome the braking force.

Further areas of applicability will become apparent from the description provided herein. The description and specific embodiments listed in this summary are for purposes of illustration only and are not intended to limit the scope of the present disclosure.

### BRIEF DESCRIPTION OF THE DRAWINGS

These and other aspects, features, and advantages of the present disclosure will be readily appreciated, as the same becomes better understood by reference to the following detailed description when considered in connection with the accompanying drawings wherein:

FIG. 1 is a side view of an example motor vehicle equipped with a power door actuation system situated between a passenger swing door and the vehicle body constructed in accordance with the teachings of the present disclosure;

FIG. 2 is a schematic, partially broken away view of a front passenger swing door shown in FIG. 1, with various components removed for clarity purposes only, which is equipped with a power door actuation system of the present disclosure;

FIGS. 3A, 3B and 3C are schematic views of a power-operated swing door drive actuator assembly associated with the power door actuation system of the present disclosure and which is operably arranged between the vehicle body and the swing door for moving the swing door between a closed position, one or more mid-positions, and an open position, respectively;

FIG. 4 is a sectional view of the power-operated swing door drive actuator assembly shown in FIGS. 3A, 3B and 3C illustrating a mechanical clutch assembly operably connecting an output shaft of a motor to a rotary drive member of the power-operated swing door drive actuator;

FIG. 5 is a flow diagram illustrating a method of operating a power-operated door system in accordance with another aspect of the disclosure;

FIG. 6 is a perspective view of a power-operated swing door actuator of the power-operated swing door drive actuator assembly of FIG. 4;

FIGS. 7 and 7A are perspective views of a mechanical clutch assembly of the power-operated swing door actuator of FIG. 6;

FIG. 8 is a side view of the power-operated swing door actuator of FIG. 6;

FIG. 8A is a cross-sectional view taken generally along the line 8A-8A of FIG. 8;

FIG. 9 is another side view of the power-operated swing door actuator of FIG. 6 looking generally along the direction of arrow 9 of FIG. 8;

FIG. 9A is a cross-sectional view taken generally along the line 9A-9A of FIG. 9;

FIG. 10A is a schematic end view of the clutch assembly of FIGS. 7 and 7A shown in a disengaged state;

FIG. 10B is a view similar to FIG. 10A with the clutch assembly shown in an engaged state;

FIG. 11 is a flow diagram illustrating another method of operating a power-operated door system in accordance with another aspect of the disclosure;

FIG. 12 is a flow diagram illustrating yet another method of operating a power-operated door system in accordance with another aspect of the disclosure;

FIG. 13 illustrates a cut-away view of a powered actuator including a constant friction device in accordance with another aspect of the disclosure;

FIG. 14 shows components of the constant friction device in accordance with another aspect of the disclosure;

FIG. 15 is a block diagram of a superposition algorithm executed by the an electronic control module or control system of the power-operated door system illustrating the inclusion of torque moments of auxiliary door systems in accordance with another aspect of the disclosure; and

FIG. 16 is a flow diagram illustrating another method of operating a power-operated door system in accordance with another aspect of the disclosure.

### DETAILED DESCRIPTION OF EXAMPLE EMBODIMENTS

In general, example embodiments of a power door actuation system having a power actuator unit, also referred to as power swing door drive actuator, constructed in accordance with the teachings of the present disclosure will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by the skilled artisan in view of the disclosure herein.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

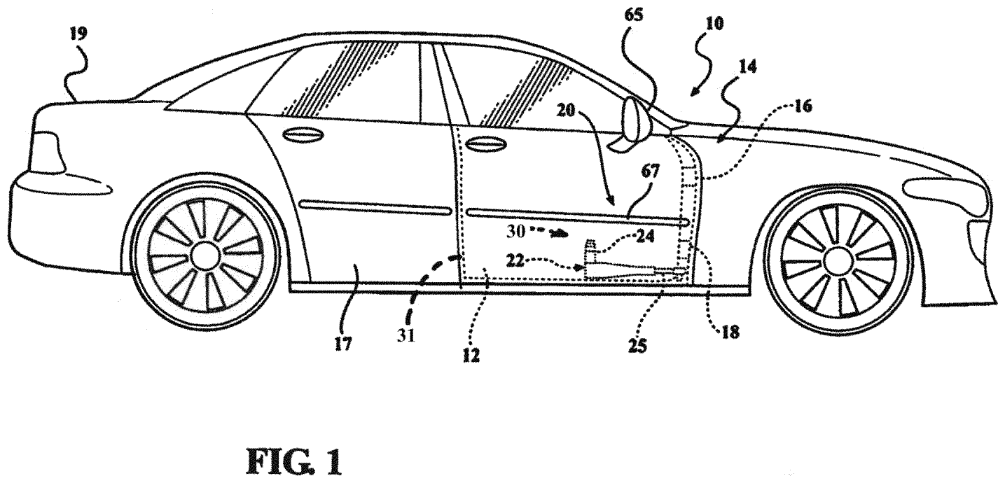

Referring initially to FIG. 1, an example motor vehicle 10 is shown to include a vehicle swing door, such as a passenger-side front door 12 pivotally mounted to a vehicle body 14 via an upper door hinge 16 and a lower door hinge 18, which are both shown in phantom lines. In accordance with a general aspect of the present disclosure, a power door actuation system 20, also shown in phantom lines, is integrated into the pivotal connection between front door 12 and the vehicle body 14. In accordance with an exemplary configuration, power door drive actuation system 20 generally includes a power-operated swing door drive actuator, also referred to as power actuator unit 22, secured within an interior chamber, also referred to as internal cavity 34, of front door 12. The power actuator unit 22 includes an electric motor 24 configured to drive an extensible actuation component or member 25 that is pivotably coupled to a portion of the vehicle body 14. Driven extension and retraction of extensible actuation member 25 via actuation of the electric motor 24 causes controlled pivotal movement of front door 12 relative to vehicle body 14. One example of a power actuator unit 22 is shown in U.S. patent application Ser. No. 17/206,198 entitled POWERED DOOR UNIT WITH IMPROVED MOUNTING ARRANGEMENT and PCT application No. CA2020051473 entitled POWERED DOOR UNIT OPTIMIZED FOR SERVO CONTROL, the contents of both applications are incorporated herein by reference in their entireties.

Each of upper door hinge 16 and lower door hinge 18 include a door-mounting hinge component and a body-mounted hinge component that are pivotably interconnected by a hinge pin or post. While power door actuation system 20 is only shown in association with front door 12, those skilled in the art will recognize that power door actuation system 20 can also be associated with any other door or liftgate of vehicle 10 such as rear doors 17 and decklid 19.

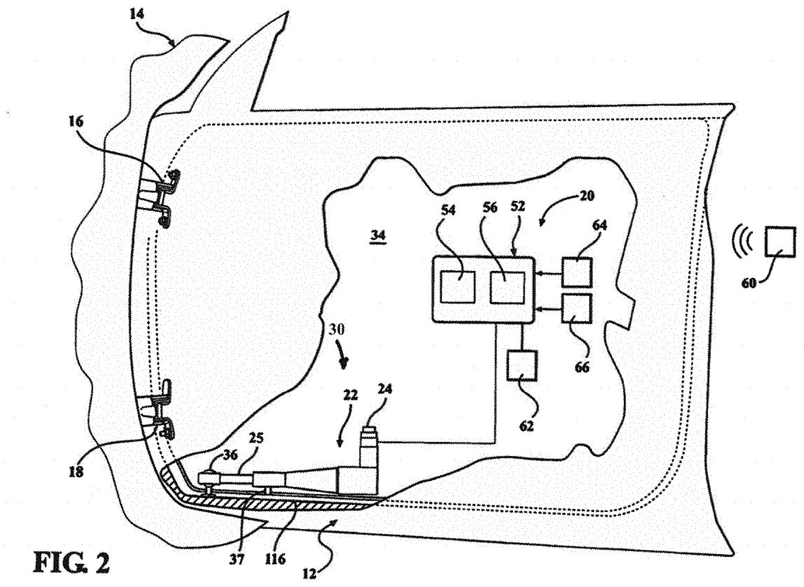

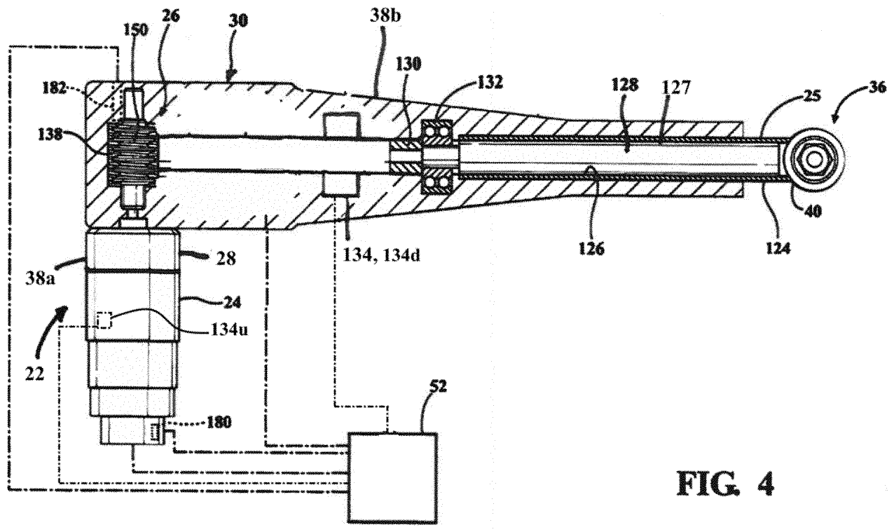

Power door actuation system 20 is diagrammatically shown in FIG. 2 to include a power drive mechanism 30, which includes power actuator unit 22 comprised of the electric motor 24, and as best shown in FIG. 4, a reduction geartrain 26, a clutch and brake assembly, also referred to as clutch/brake assembly 28, and extensible actuation component member 25, which together are mounted within an interior chamber, also referred to as interior or internal cavity 34, of door 12 between inner and outer panels of the door 12. Power drive mechanism 30 also includes a first connector mechanism 36 configured to connect a terminal end 40 of the extensible actuation member 25 of power drive mechanism 30 to vehicle body 14 and further includes a support structure, such as a power actuator unit housing 38a and extensible actuation component member housing 38b, configured to be secured to swing door 12 within a lowermost region of interior chamber 34, such as to a lowermost wall delimiting a lowermost portion of interior chamber 34, also referred to as floor 116, via a second connector mechanism 37 and to enclose or operably attach to electric motor 24, and to enclose reduction geartrain 26, clutch/brake assembly 28 and extensible actuation component or member 25 therein. Power drive mechanism 30 is shown in this non-limiting arrangement to be located below lower hinge 18 in a lowermost region of interior chamber 34. As also shown in FIG. 2, an electronic control module 52 is in communication with electric motor 24 for providing electric control signals thereto. Electronic control module 52 includes a microprocessor 54 and a memory 56 having executable computer readable instructions stored thereon for commanding movement and control of the power drive mechanism 30 and power actuator unit 22 thereof. Electronic control module 52 can be integrated into, directly connected to actuator housing 38, or otherwise electrically coupled for communication with motor 24.

Although not expressly illustrated, electric motor 24 can include Hall-effect sensors for monitoring a position and speed of vehicle door 12 during movement between its open and closed positions. For example, one or more Hall-effect sensors may be provided and positioned to send signals to electronic control module 52 that are indicative of rotational movement of electric motor 24 and indicative of the rotational speed of electric motor 24 (e.g., based on counting signals from the Hall-effect sensor detecting a target on a motor output shaft). In situations where the sensed motor speed is greater than a threshold speed and where a current sensor 180 (FIG. 4) registers a significant change in the current draw, electronic control module 52 may determine that the user is manually moving vehicle door 12 while electric motor 24 is also operating, thus moving vehicle door 12 between its open and closed positions. Electronic control module 52 may then send a signal to electric motor 24 to de-energize and stop electric motor 24. Conversely, when electronic control module 52 is in a power open or power close mode and the Hall-effect sensors indicate that a speed of electric motor 24 is less than a threshold speed (e.g., zero) and a current spike is registered, electronic control module 52 may determine that an obstacle is in the way of vehicle door 12, in which case the electronic control system may take any suitable action, such as sending a signal to de-energize and turn off electric motor 24. As such, electronic control module 52 receives feedback from the Hall-effect sensors to ensure that a contact obstacle has not occurred during movement of vehicle door 12 from the closed position to the open position, or vice versa.

As is also schematically shown in FIG. 2, electronic control module 52 can be in communication with a remote key fob 60 and/or with an internal/external handle switch 62 for receiving a request from a user to open or close vehicle door 12. Put another way, electronic control module 52 receives a command signal from either remote key fob 60 and/or internal/external handle switch 62 to initiate an opening or closing of vehicle door 12. Upon receiving a command, electronic control module 52 proceeds to provide a signal to electric motor 24 in the form of a pulse width modulated voltage (for speed control) to energize and turn on electric motor 24 and initiate pivotal swinging movement of vehicle door 12. While providing the signal, electronic control module 52 also obtains feedback from the Hall-effect sensors of electric motor 24 to ensure that a contact obstacle has not occurred. If no obstacle is present, electric motor 24 will continue to generate a rotational force to actuate extensible actuation member 25. Once vehicle swing door 12 is positioned at the desired location, electric motor 24 is de-energized and turned off and a “self-locking” mechanism associated with clutch/brake assembly 28 causes vehicle swing door 12 to continue to be held at that location. If a user tries to move vehicle swing door 12 to a different operating position, clutch/brake assembly 28 will resist the user's motion (thereby replicating a door check function).

Electronic control module 52 can also receive an additional input from an ultrasonic sensor 64 positioned on a portion of vehicle door 12, such as on a door mirror 65 or the like. Other types of proximity sensors, such as radar or other electromechanical-based proximity sensor can be used. Ultrasonic sensor 64 assesses if an obstacle, such as another car, tree, or post, is near or in close proximity to vehicle door 12. If such an obstacle is present, ultrasonic sensor 64 will send a signal to electronic control module 52 and electronic control module 52 will proceed to de-energize and turn off electric motor 24 to stop movement of vehicle door 12, thereby preventing vehicle door 12 from hitting the obstacle. This provides a non-contact obstacle avoidance system. In addition, or optionally, a contact obstacle avoidance system can be placed in vehicle 10 which includes a contact sensor 66 mounted to door, such as in association with molding component 67, and which is operable to send a signal to controller 52.

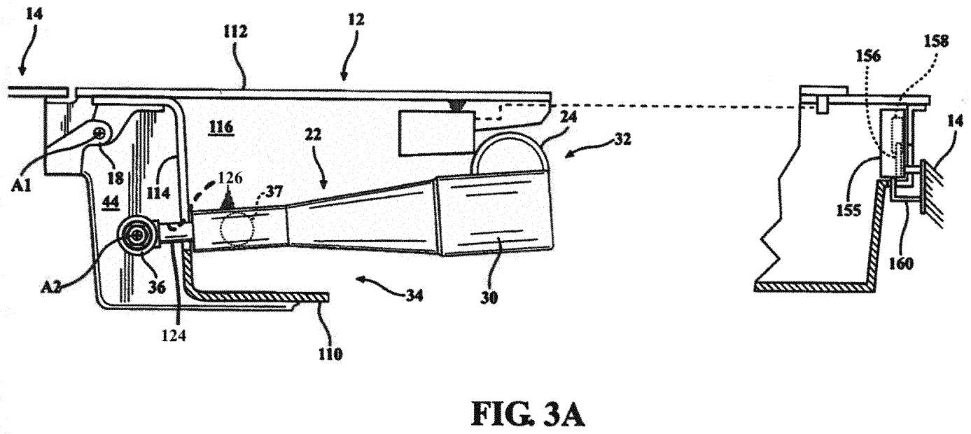

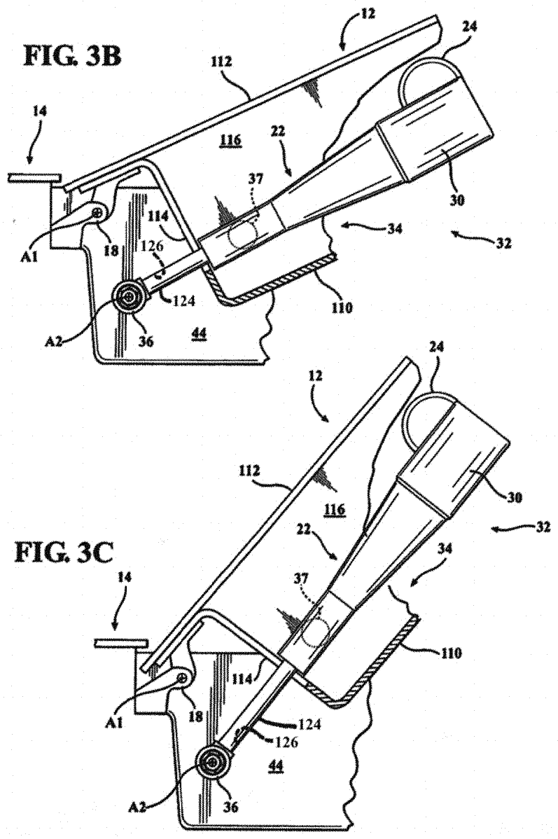

FIGS. 3A, 3B and 3C show a non-limiting embodiment of the power-operated swing door drive actuator 22 in operation to move the vehicular swing door 12 between a closed position, an intermediate open position, and a fully-open position, respectively. The swing door 12 is pivotally mounted by the aforementioned pair of upper and lower door hinges, with only the lower door hinge 18 shown, connected to the vehicle body 14 (not shown in its entirety) for rotation about a generally vertical door hinge axis A1. For greater clarity, the vehicle body 14 is intended to include the ‘non-moving’ structural elements of the vehicle 10 such as the vehicle frame (not shown) and body panels (not shown).

The swing door 12 includes inner and outer sheet metal panels 110 and 112 with a connecting portion 114 between the inner and outer sheet metal panels 110 and 112. The power actuator unit 22 is shown including a support structure, such as the housing 38a, the extensible actuation component or member 25 mounted within housing 38b, and the extensible actuation member 25 drivingly coupled to power actuator unit 22. The extensible actuation member 25 is moveable relative to housing 38b between retracted and extended positions to effectuate swinging movement of swing door 12. The power actuator unit 22 can be mounted within the lowermost region of the internal door cavity 34 formed between the inner and outer sheet metal panels 110, 112. Specifically, the extensible actuation member housing 38b is fixed to the swing door 12 via the second connector mechanism 37 mounted to the connecting door portion 114 immediately adjacent a bottom wall, also referred to as floor 116, within the internal door cavity 34. The terminal end 40 of the extensible actuation member 25 is mounted to the vehicle body 14 below the lower door hinge 18 in laterally spaced relation from the door hinge axis A1, such that a pivot axis A2 of the terminal end 40 is laterally spaced from door hinge axis A1, thereby providing a lever or moment arm for enhanced pivotal movement of swing door 12. It is recognized that the provision of a laterally offset door hinge axis A1 and pivot axis A2 can provide a moment arm and increase mechanical advantage such that a smaller, less powerful power actuator unit 22 may be provided to open and close the swing door 12 as compared to a mounting of a power actuator unit to a shut face 31 to which upper and lower door hinges 16, 18 are fixed and whereat the door hinge axis and the pivot axis are not laterally spaced apart from one another or the lateral spacing is limited by the width of the shut face 31, and not as great as a lateral spacing as available in the embodiment where the terminal end 40 is connected to a horizontally extending door sill, also referred to as rocker panel 44. It is also recognized that the terminal end 40 is connected to the rocker panel 44 relative to the door hinge axis A1 at a location that can allow the swing door 12 to be opened at a wider angle relative to the vehicle body 14, i.e. away from the body 14 up to a perpendicular, or greater than perpendicular relationship with the body 14. It is also recognized that mounting the terminal end 40 to the rocker panel 44 can provide different mounting options as compared to the shut face 31, due to the shut face 31 being populated with the hinge mounting points, apertures for wires, air ducts, and door checks at other connections. While mounting the terminal end 40 to the shut face 31 is possible, the mounting to the rocket panel 44 offers less obstacles in positioning and increase leverage, as discussed above.

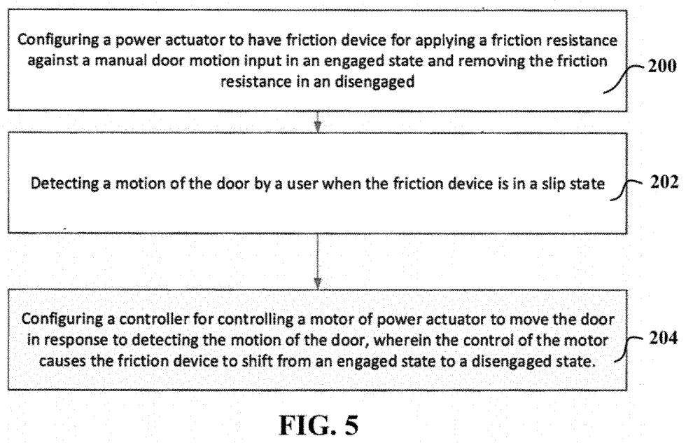

Referring additionally to the sectional view of the power-operated swing door drive actuator 22 shown in FIG. 4, the housing 38b defines a cylindrical chamber in which the extensible actuation member 25 slides. The extensible actuation member 25 includes the first connector mechanism 36, such as one of a ball or ball socket at the terminal end 40 of a cylindrical tube 124 for pivotal attachment to the other of a corresponding ball or ball socket on the vehicle body 14. The cylindrical tube 124 is formed to include internal threads 126. The internally-threaded cylindrical tube 124 (also referred to as a “nut tube”) meshingly engages with external threads 127 formed on a rotary drive member, i.e. lead screw 128 (FIG. 5) that is mounted in the housing 38b for rotation in situ. The lead screw 128 is mateable with the internally-threaded nut tube 124 to permit relative rotation between lead screw 128 and the internally-threaded nut tube 124. In the embodiment shown, because the nut tube 124 is slidably connected in the housing 38b but is held against rotation, as the lead screw 128 rotates the nut tube 124 translates linearly, thereby causing the extensible actuation member 25 to move with respect to the housing 38b. Since the extensible actuation member 25 is connected to the vehicle body 14 and the actuator housing 38b is connected to the swing door 12, such movement of the extensible actuation member 25 causes the swing door 12 to pivot relative to the vehicle body 14.

The lead screw 128 is shown, by way of example and without limitation, as being fixed to a shaft 130, either as a monolithic piece of material or as separate pieces of material fixed to one another, that is journalled in the housing 38b via ball bearing 132 that provides radial and linear support for the lead screw 128. In the illustrated non-limiting embodiment, an absolute position sensor 134 is mounted to the shaft 130. The absolute position sensor 134 translates lead screw rotations into an absolute linear position signal so that the linear position of the extensible actuation member 25 is known with certainty, even upon power up. In alternative embodiments, the position sensor 134 can be a hall sensor for detecting the rotations of the shaft 130, for example by detecting a magnet secured to the shaft 30 entering and leaving a detection zone of the hall sensor 134 as the shaft rotates. In alternative embodiments, the absolute linear position sensor 134 can be provided by a linear encoder mounted between the nut tube 124 and extensible actuation member housing 38b which reads the travel between these components along a longitudinal axis. As shown in FIG. 4, the absolute position sensor 134 is provided downstream from the brake mechanism 28 such that any delays in motion of the door 12 after activation of the motor 24 due to the transition of the brake mechanism 28 (e.g., compression of a wave spring, discussed in more detail below) do not affect the haptic/servo or power assist control, in that the position signal of the door 12 communicated to the electronic control module 52 remains absolute as compared to a position sensor provided upstream the brake mechanism 28. In other words, if the brake mechanism 28 introduces slop or play, the delay in disengaging the brake mechanism 28 due to activation of motor 24 does not affect the electronic control module 52 since the motion of the door 12 is picked up only after the wave spring of the brake mechanism 28 has been compressed due to position of the absolute position sensor 134. In another possible configuration as shown in FIG. 4, the position sensor 134 is shown as a position sensor 134d provided downstream from the clutch/brake assembly 28 and further provided is another position sensor 134u positioned upstream the clutch/brake assembly 28 such that any delays, if existing, in the motion of the door 12 after activation of the motor 24 due to the transition of the clutch/brake assembly 28 between different states (for example due to a compression of a wrap spring 74, as discussed in more detail below) do not affect the haptic/servo control or power assist of the motor 24, in that the position signal of the door 12 communicated to the electronic control module 52 can be determined by the electronic control module 52 comparing a position signal from upstream sensor 134u to a position signal from downstream sensor 134d. For example, the electronic control module 52 may control the motor 24 to move the door 12 and detect a signal from upstream sensor 134u but not detect a signal from downstream sensor 134d due to a lag introduced by clutch/brake assembly 28, for example as will be described in more detail herein below. The electronic control module 52 therefore is aware that the energization of the motor 24 does not result into an instantaneous and corresponding movement of the door until the electronic control module 52 detects a signal from both upstream sensor 134u and a signal from downstream sensor 134d which can be signals having similar or identical or relative rates indicating to the controller 52 that the motor 24 rotation imparts a corresponding motion of the components downstream clutch/brake assembly 28. Upstream sensor 134u can be configured for detecting various components upstream the clutch/brake assembly 28, and is shown in FIG. 4 to detect a rotation of the motor shaft of motor 24 as one possible example. The shaft 130 is operably connected to the clutch/brake assembly 28 via a worm gear 138 (FIG. 4), wherein worm gear 138 can be formed on shaft 130 or fixed thereto. The worm gear 138 may be a helical gear that meshes with a worm 150 that is operably connected to the output shaft 70 of the electric motor 24 via intervening clutch/brake assembly 28. The worm 150 may be a single start worm having a thread with a lead angle of less than about 4 degrees, by way of example and without limitation. The geartrain unit 26 is thus provided by the worm 150 and worm gear 138 and provides a gear ratio that multiplies the torque of the motor as necessary to drive the lead screw 128 and move the vehicle swing door 12. The electric motor 24 is operatively connected to the geartrain unit 26 and is operatively connected to an input end 28a of the clutch brake assembly 28 through an output shaft, also referred to as motor shaft 70. An output end 28b of the clutch/brake assembly 28 is operatively connected to the extensible actuation member 25 (in the embodiment shown, through worm 150, worm gear 138 and shaft 130).

It will be noted that the worm 150, worm gear 138 and shaft 130 are just one example of an operative connection between the output end 28b of the clutch/brake assembly 28 and the extensible actuation member 25. Any other suitable operative connection may be provided between the output end 28b of the clutch/brake assembly 28 to the extensible actuation member 25 for converting the rotary motion of the output end 28b into extension and retraction of the extensible actuation member 25. Furthermore, the lead screw 128 and nut tube 124 are just one example of a rotary-to-linear conversion mechanism operable to convert rotary motion (i.e. the rotary motion associated with the output end 28b of the clutch/brake assembly 28) into substantially linear motion which drives the extension and retraction of the extensible actuation member 25 relative to the housing 38b.

As shown in FIG. 3A, control system 52 may also be operatively connected to a door latch, shown at 155, that is provided as part of the swing door 12. The door latch 155 may include a latch mechanism having a ratchet 156 and a pawl 158, both of which may be any suitable ratchet and pawl known in the art. The ratchet 156 is movable between a closed position wherein the ratchet 156 holds a striker 160 that is mounted to the vehicle body 14 and an open position wherein the striker 160 is not held by the ratchet 156. When the ratchet 156 is in the closed position, the door latch 155 may be said to be closed (FIGS. 1, 3A). When the ratchet 156 is in the open position, the door latch 155 may be said to be open (FIGS. 3B, 3C). The pawl 158 is movable between a ratchet locking position wherein the pawl 158 holds the ratchet 156 in the closed position and a ratchet release position wherein the pawl 158 permits movement of the ratchet 156 to the open position. Any other suitable components may be provided as part of the door latch 155, such as components for locking and unlocking the swing door 12, and motors for causing movement of the pawl 158 between the ratchet locking and ratchet release positions.

The electronic control module or control system 52 provides system logic for selectively powering the electric motor 24 based on a number of signal inputs. The control system 52 may include the microprocessor 54 and memory 56 that contains programming that is configured to carry out the method steps described below, and may be configured to receive inputs and transmit outputs as described below.

While the non-limiting example of the control system 52 has been shown in FIG. 4 as a single block, it will be understood by persons skilled in the art that in practice the control system 52 may be a complex distributed control system having multiple individual controllers connected to one another over a network.

The control system 52 can operate in a ‘power assist’ mode where the control system 52 determines that a user is trying to manually move the swing door 12 when the power-operated swing door drive actuator 22 is in a power open or power close mode. For example, the electronic control module or control system 52 may operate in a power assist mode and/or an automatic mode illustratively described in co-owned international patent application No. WO2020252601A1 entitled “A power closure member actuation system”, the entire contents of which are incorporated herein by reference in its entirety, and herein referred to as the “601 patent application”. The electronic control module or control system 52 can operate in the power assist mode as in for example a haptic or servo mode of operation whereby for example the user's input on the door, such as push or pull, influences the power assist control operation which can increase or decrease the motor force output accordingly, and the power assist control provides a change to the experience of the user when the user inputs the door, such as changing the user change in the door's weight from heavy to light. Again, the current sensor 180 (FIG. 4) may be provided for the electric motor 24 for determining the amount of current drawn by the motor 24. One or more Hall-effect sensors (one is shown at 182) may be provided and positioned to send signals to the control system 52 that are indicative of rotational movement of the electric motor 24 and indicative of the rotational speed of the electric motor 24 (e.g., based on counting signals from the Hall-effect sensor 182 detecting a target on the motor output shaft). Other types of position sensors such as encoders may be used. In situations where the sensed motor speed is greater than a threshold speed and where the current sensor registers a significant change in the current draw, or the hall sensors register rotation of the motor output shaft, the control system 52 may determine that the user is manually moving the swing door 12 while the electric motor 24 is also moving the swing door 12, and that therefore the user wishes to manually move the swing door 12. The control system 52 may then de-energize and stop the electric motor 24, which in turn causes clutch/brake assembly 28 to be engaged, as discussed further below. Conversely, when the control system 52 is in the power open or close mode and the Hall-effect sensors indicate that the motor speed is less than a threshold speed (e.g. zero) and a current spike is registered, the control system 52 may determine that an obstacle is in the way of the swing door 12, in which case the control system 52 may take any suitable action, such as stopping the electric motor 24. As an alternative, the control system 52 may detect that the user wants to initiate manual movement of the swing door 12 if signals from the absolute position sensor 134 indicate movement of the extensible actuation member 25 at a time when the swing motor 24 is not powered. In situations where the electric motor 24 is deactivated and which in turn causes clutch/brake assembly 28 to be engaged to hold the door at a position, such as at a partially open position, the control system 52 may be shifted to operate in a power assist mode when a motion of the door 12 is detected. Such motion of the door 12 indicates a user has manual control of the door 12 and is desirous to move the door 12 away from the held position. For example, detection of motion of the door 12 can include sensing an increase in a speed of the electric motor 24 above a threshold speed and where the current sensor 180 registers a significant change in the current draw and/or the Hall sensors 182 register rotation of the motor output shaft 70 due to the user having overcome a friction force applied by the clutch/brake assembly 28 in an engaged state to allow a slip state to exist. As a result of detecting motion of the door 12, the control system 52 may determine that the user is manually moving the swing door 12, while the electric motor 24 is not moving the swing door 12, and that therefore the user wishes to manually move the swing door 12 in a power assist mode. In response to the detection of a manual door motion, the control system 52 may then energize the electric motor 24, which in turn causes clutch/brake assembly 28 to disengage, as discussed further below such that the motor 24 may provided assistance to the user moving the door 12. The control system 52 can be configured similarly to the teachings of the '601 patent application now described with reference to elements of the '601 patent application yet offset by a factor of prime “′”. For example, the control system 52 can be configured similarly to controller 50′ as described in the '601 patent application, where the controller 50′ is also configured to receive the motion input 56′, where the motion input 56′ is as a result of a user overcoming at least the frictional braking force or resistance of clutch/brake assembly 28 in a slip condition resisting motion of the door 12, and enter the powered assist mode to output the force command 88′ (e.g., using a force command generator 98′ of the controller 50′ as a function of a force command algorithm 100′, door model 102′, boundary conditions 91′, a plurality of closure member component profiles 106′. The controller 50′ can also be configured to generate the force command 88′ to control an actuator output force acting on the closure member to move the closure member 12. So, the controller 50′ varies an actuator output force acting on the closure member or door 12 to move the closure member 12 in response to receiving the motion input 56′. The power closure member actuation system 20 may be configured to initially overcome the spring bias of the clutch/brake assembly 28 required to shift the clutch/brake assembly 28 from the brake engaged state to the brake disengaged state and to compensate for the spring force of the clutch/brake assembly 28 tending to shift the clutch/brake assembly 28 towards the brake engaged states after the clutch/brake assembly 28′ has been shifted to the disengaged state to negate any effects on the closure member motion that the clutch/brake assembly 28 may cause the user to experience. The door model 102′ and/or the force command algorithm 100′ may be adapted accordingly to include the model of the clutch/brake assembly 28 for use by the controller 50′ to determine the force command 88′ when the controller 50′ is controlling an actuator including the clutch/brake assembly 28.

Now referring to FIG. 5, steps of a method of operating the power closure member actuation system 20 are shown. The method includes the step of 200 configuring a power actuator 22 to have a brake mechanism in the form of a clutch and brake assembly 28 for applying a friction resistance against a manual door motion input in an engaged state and removing the friction resistance in a disengaged state. The method continues with the step of 202 detecting motion of a door 12 by a user when the clutch and brake assembly 28 is in a slip state. The method also includes the step of 204 configuring an electronic control module 52 for controlling an electric motor 24 of the power actuator 22 to move the door 12 in response to detecting motion of the door 12, wherein the control of the electric motor 24 causes the clutch/brake and assembly 28 to shift from the engaged state to the disengaged state.

The swing door actuation systems 20 of the present disclosure enable a powered open and powered close of the vehicular swing door 12, where the normally engaged clutch/brake assembly 28 enables the motor 24 and the gear train 26 to rotatably drive the lead screw 128 in order to extend and retract the tubular cylinder nut 124 resulting in extension of the extensible actuation member 25 in a first direction for opening swing door 12 and retraction of the extensible actuation member 25 in a second direction for closing the swing door 12.

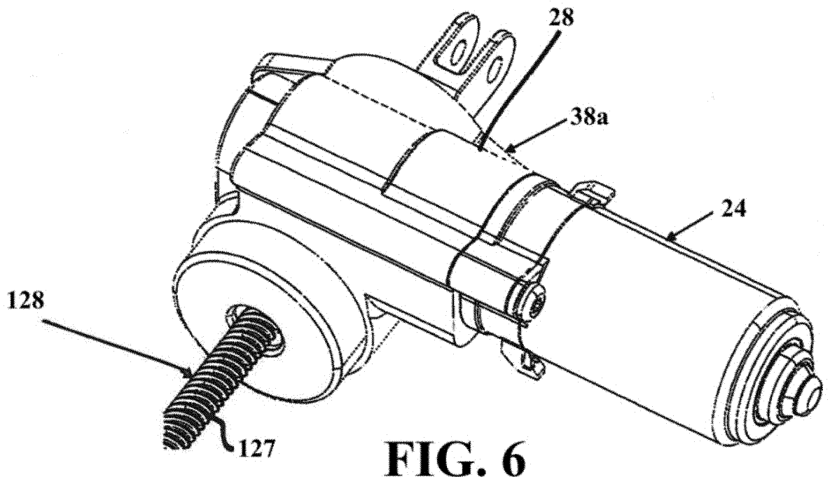

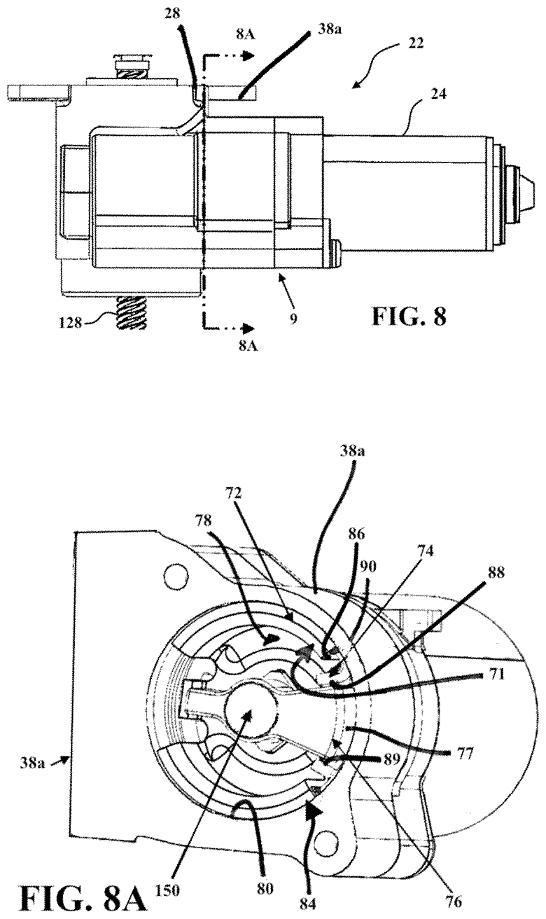

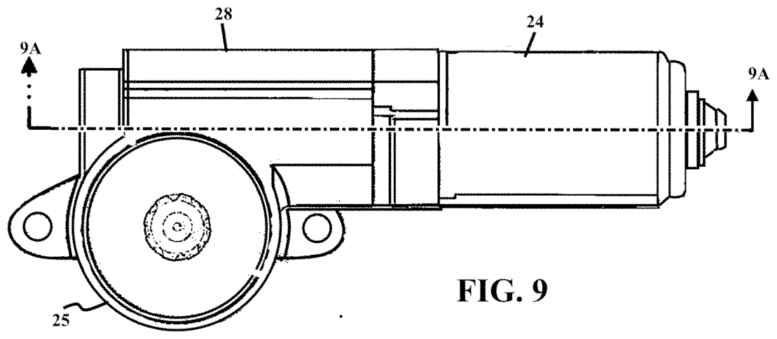

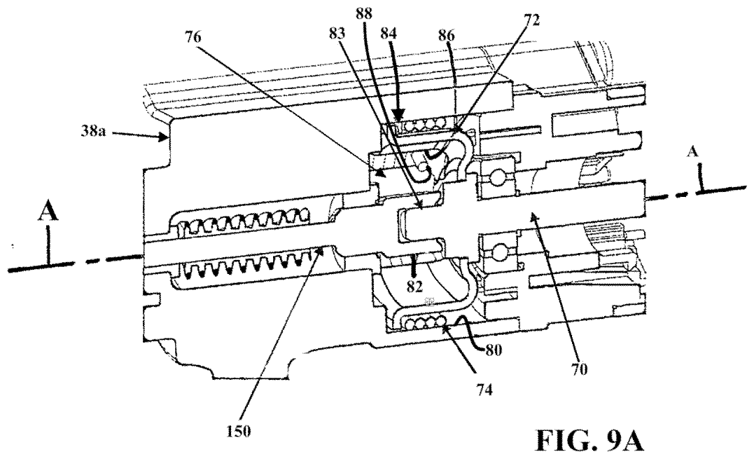

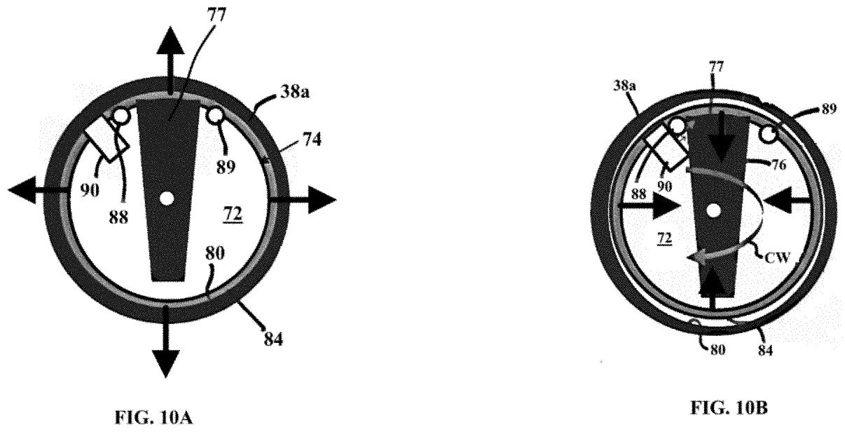

The clutch/brake assembly 28 is discussed in more detail hereafter with reference to FIGS. 6 through 10B. Clutch/brake assembly 28 operably connects the electric motor 24 and the motor shaft 70 driven thereby with the extensible actuation member 25 and the lead screw 128 thereof. Clutch/brake assembly 28 is moveable from a disengaged state (FIG. 10A), whereat the extensible actuation member 25 is inhibited from moving axially relative to the extensible actuation member housing 38b, to an engaged state (FIG. 10B), whereat the extensible actuation member 25 is able to be powered to move axially between the extended and retracted states relative to the extensible actuation member housing 38b. Clutch/brake assembly 28 moves from the disengaged state to the engaged state in direct response to the electric motor 24 being switched from the de-energized state to the energized state, respectively. As such, it is to be understood that while clutch/brake assembly 28 is in its disengaged state, due to electric motor 24 being de-energized, a purely mechanically actuatable brake mechanism 71 (FIG. 8A) is in an engaged state, whereat extensible actuation member 25 is inhibited from moving axially relative to the extensible actuation member housing 38b. Further, while clutch/brake assembly 28 is in its engaged state, brake mechanism 71 is in a disengaged state, due to electric motor 24 being energized, whereat extensible actuation member 25 is able to move axially relative to the extensible actuation member housing 38b between its extended and retracted positions to move vehicle door 12 between it open and closed positions, respectively.

Clutch/brake assembly 28 includes a drive member 72, an engagement/disengagement member, shown as a spring member 74, by way of example and without limitation, and a driven member 76. Spring member 74 is disposed in a cavity 78 bounded by an inner wall 80 of the clutch/brake housing 38a, wherein spring member 74 is automatically biased, in its relaxed state, to a radially expanded state, whereat an outer surface of spring member 74 is in locked engagement with an inner wall 80 of housing 38a (it is to be understood that although the spring member 74 is stated as being in a relaxed state, that the spring member 74 is radially constrained from being in its fully relaxed state by the inner wall 80 of the housing 38a, and thus, friction is established between the spring member 74 and the inner wall 80). Spring member 74 is in its relaxed, radially expanded state when the electric motor 24 is in the de-energized state, whereat extensible actuation member 25 is inhibited from moving in the retracted direction, also referred to as second direction, to inhibit the vehicle swing door 12 from moving from the open position toward the closed position. Accordingly, when electric motor 24 is in the de-energized state, spring member 74 is automatically and mechanically radially expanded into braking relation with inner wall 80, thereby inhibiting retraction of cylindrical tube 124 within housing 38b, and thus, vehicle door 12 is temporarily inhibited from moving from its open position toward the closed position. Accordingly, while in its relaxed state, the frictional force established between spring member 74 and inner wall 80 is sufficiently strong to inhibit retraction of cylindrical tube 124 within housing 38b.

While the vehicle swing door 12 is in the open position, and while the electric motor 24 is in the de-energized state, any movement of the extensible actuation member 25 in the second direction (retracted direction), whether from gravity, wind and/or some other externally applied force, causes the driven member 76, which is operably coupled to the extensible actuation member 25, shown as by being fixed to an output member, such as an end 82 of worm 150 that is coupled with an end 83 of motor shaft 70, to forcibly engage an end 88 of spring member 74 and increase the bias of the spring member 74 in an unwinding direction toward the radially expanded state. The increased unwinding bias of spring member 74 increases locked engagement of the outer surface of spring member 74 with the inner wall 80, thus, further inhibiting the vehicle swing door 12 from moving in the closing direction toward the closed position. In one possible configuration, the locked engagement of the spring member 74 with the inner wall 80 may be configured to be overcome above a threshold force input applied to the extensible actuation member 25 in the second direction (retracted direction), for example from a user applying a force to the vehicle swing door 12 which may be greater than gravity, wind and/or some other non-user externally applied force in order to allow the swing door 12 which may be desirable in the event of a power failure condition where swing door movement 12 cannot be powered for motion via actuation of electric motor 24, or other failure condition, which may allow for a manual movement of the swing door 12 by the user. For example the engagement of the outer surface of spring member 74 with the inner wall 80 may be configured to allow a slip state of the outer surface of spring member 74 with the inner wall 80 above an input threshold to the extensible actuation member 25. For example the number of spring members 74 may be tuned to reduce the surface area in contact with the inner wall 80 to allow a braking state of the spring member 74 with the inner wall 80 below an input force, or below a predetermined force threshold applied to the extensible actuation member 25 imparted as a result of a manual movement to the swing door 12 to prevent movement of the door 12, while allowing an override non-braking state of the spring member 74 with the inner wall 80 above an input force, or above the predetermined force threshold, applied to the extensible actuation member 25 imparted as a result of a manual movement to the swing door 12. Other manners of providing such an override state to the clutch/brake assembly 28 may include selection of materials of the spring member 74 and the inner wall 80, configuration of the engagement surface between the spring member 74 with the inner wall 80, the dimensions and shape of the spring member 74, as examples without limitation. The methods and devices described herein may therefore optionally include the steps or configurations of the clutch and brake assembly 28 to include a braking state wherein the extensible actuation member 25 is inhibited from moving in the second direction to inhibit the vehicle swing door 12 from moving from the open position toward or away from the closed position in response to a manual force below a predetermined threshold applied to the swing door 12, and to include an override state wherein the extensible actuation member 25 is allowed to move in the second direction to allow the vehicle swing door 12 to move from the open position toward or away from the closed position in response to a manual force above the predetermined threshold applied to the swing door 12.

Motor shaft 70 and a shaft of worm 150 are coaxially aligned with one another along an axis A, with the end 83 of motor shaft 70 and the end 82 of worm 150 being configured for sliding axial movement with one another along axis A in plunger-like fashion. End 83 of motor shaft 70 and end 82 of worm 150 remain coupled with one another along axis A for fixed coaxial rotation while the clutch/brake assembly 28 is in its engaged state, and for relative rotation with one another when the clutch/brake assembly 28 is changed from its engaged state to its disengaged state, upon electric motor 24 being de-energized. In other words, motor shaft 70 and the worm shaft 150 are allowed to rotate relative to each other to allow the clutch 28 to engage and disengage. As such, as discussed above, the bias of spring member 74 against inner wall 80 allows spring member 74 to automatically return to is radially expanded state to bring the outer surface of spring member 74 into braking relation with inner wall 80 of housing 38a as soon as electric motor 24 is de-energized.

Upon electric motor 24 being energized, an input member, shown as motor shaft 70, drives drive member 72 rotatably, either via direct connection or indirect and operable connection thereto, such as via intermediate gears, connectors, or the like. Drive member 72, via engagement with end 88 of spring member 74, winds spring member 74 against the spring bias thereof to a radially contracted state, also referred to a constricted state, into operable engagement with driven member 76. Driven member 76 is shown as an elongate arm, also referred to as fork, fixed to, directly or indirectly, and extending radially outwardly from worm 150 in transverse relation to axis A to a free end region 77. Driven member 76 is operably coupled to the extensible actuation member 25, such as via reduction gear train 26 formed by worm 150 and worm gear 138, by way of example and without limitation. With spring member 74 being constricted, spring member 74 is spaced radially inwardly from the inner wall 80, out of braking frictional contact with inner wall 80, whereat extensible actuation member 25 is freely drivable in the first direction (extended direction) to move the vehicle swing door 12 from the closed position toward the open position.

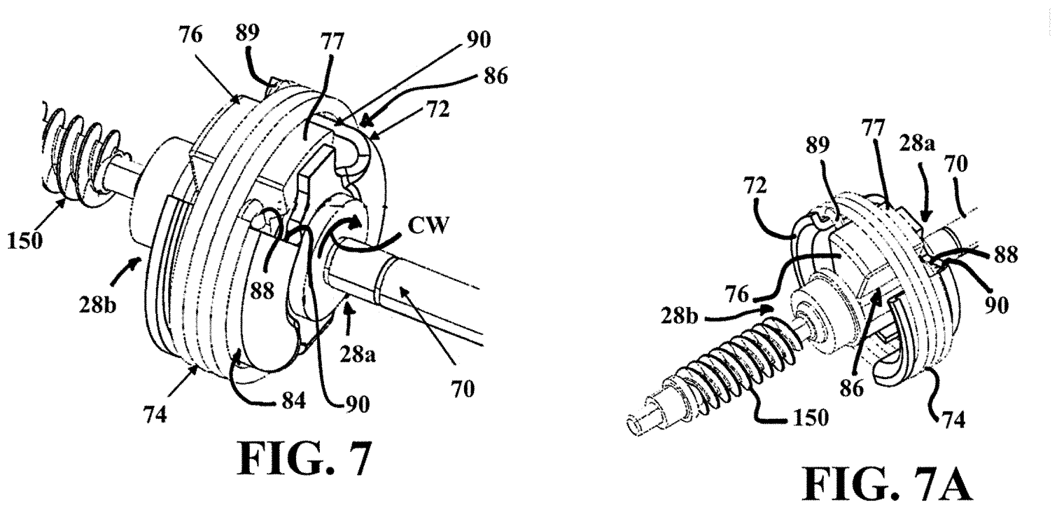

Drive member 72 is provided as a generally bowl-shaped clutch plate having a generally cylindrical outer wall region 84, with generally cylindrical intended to mean the outer wall region 84 can be truly cylindrical or slightly less than a true cylinder form. Spring member 74 is disposed about the generally cylindrical outer wall region, referred to hereafter as outer wall region 84. Spring member 74 is shown as a coil spring, by way of example and without limitation, in expanded engagement with the inner wall 80 of outer wall region 84 and in releasably fixed frictional engagement with inner wall 80 while in the radially expanded state, whereat electric motor 24 is in the de-energized state. In contrast, spring member 74 is in radially constricted in slightly spaced relation from outer wall region 84 and out of frictional engagement from inner wall 80 while in the radially contracted state, whereat electric motor 24 is in the energized state. Outer wall region 84 is shown as having a notch 86 in the form of a window, also referred to as cutout region, with opposite ends 88, 89 of spring member 74 being disposed therein in radially inwardly extending relation. As such, an edge region, also referred to as flange 90, bounding a portion of notch 86, is brought into driving engagement with end 88 to drive end 88 in a clockwise direction CW, as viewed in FIGS. 7 and 10B, thereby causing spring member 74 to constrict radially against its internal, natural bias, with end 88 being brought into driving engagement with driven member, (i.e., fork 76), thereby causing worm 150 to be driven conjointly with fork 76, whereat worm 150 drives worm gear 138 and shaft 130/lead screw 128 to effectuate extension of cylindrical tube 124 and vehicle door 12 toward the open position. So, rotation of the fork 76 in a counter clockwise direction caused by movement of the worm gear 150 will act on the ends 88, 89 to cause the spring 74 to expand and lock the clutch 28 against the inner housing wall.

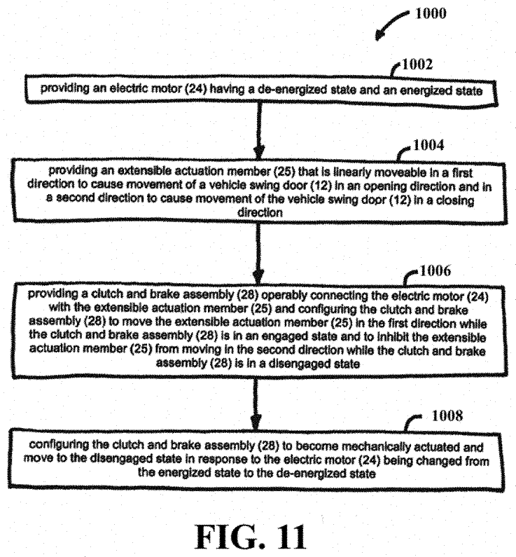

In accordance with another aspect of the disclosure and referring to FIG. 11, a method of 1000 operating a power actuator unit 22 and inhibiting unwanted, inadvertent movement of a vehicle swing door 12 from an open position toward a closed position is provided. The method 1000 includes, a step 1002 of providing an electric motor 24 having a de-energized state and an energized state and a step 1004 of providing an extensible actuation member 25 that is linearly moveable in a first direction to cause movement of the vehicle swing door 12 in an opening direction and in a second direction to cause movement of the vehicle swing door 12 in a closing direction. Further, a step 1006 of providing a clutch/brake assembly 28 that operably connects the electric motor 24 with the extensible actuation member 25 and configuring the clutch/brake assembly 28 to drive and move the extensible actuation member 25 in the first direction while the clutch/brake assembly 28 is in an engaged state, and further, configuring the clutch/brake assembly 28 to inhibit the extensible actuation member 25 from moving in the second direction while the clutch/brake assembly 28 is in a disengaged state. Further yet, a step 1008 of configuring the clutch/brake assembly 28 to become mechanically actuated, without need of electrical power, and automatically move to the disengaged state in response to the electric motor 24 being changed from the energized state to the de-energized state.

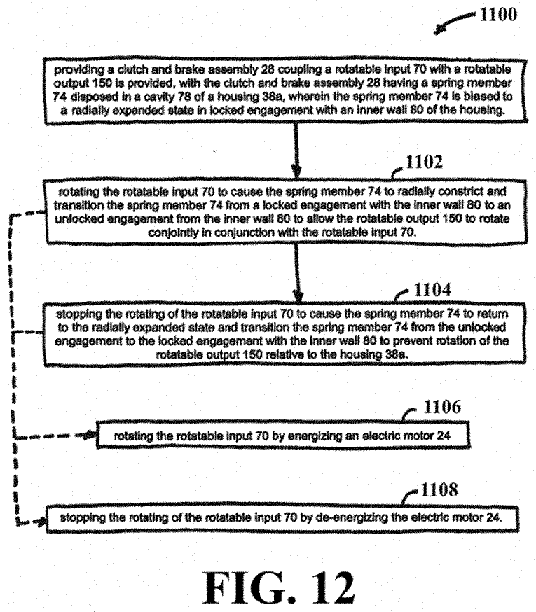

In accordance with another aspect of the disclosure and referring to FIG. 12, another method 1100 of operating a clutch and brake assembly 28 coupling a rotatable input 70 with a rotatable output 150 is provided. The clutch and brake assembly 28 includes a spring member 74 disposed in a cavity 78 of a housing 38a. The spring member 74 is biased to a radially expanded state in locked engagement with an inner wall 80 of the housing 38a. The method 1100 includes a step 1102 of rotating the rotatable input 70 to cause the spring member 74 to radially constrict and transition the spring member 74 from a locked engagement with the inner wall 80 to an unlocked engagement from the inner wall 80 to allow the rotatable output 150 to rotate conjointly in conjunction with the rotatable input 70. The method 1100 further includes a step 1104 of stopping the rotating of the rotatable input 70 to cause the spring member 74 to return to the radially expanded state and transition the spring member 74 from the unlocked engagement to the locked engagement with the inner wall 80 to prevent rotation of the rotatable output 150 relative to the housing 38a.

The step 1102 of rotating the rotatable input 70 can be performed by a step 1106 of energizing an electric motor 24 and the step 1104 of stopping the rotating of the rotatable input 70 can be performed by a step 1108 of de-energizing the electric motor 24.

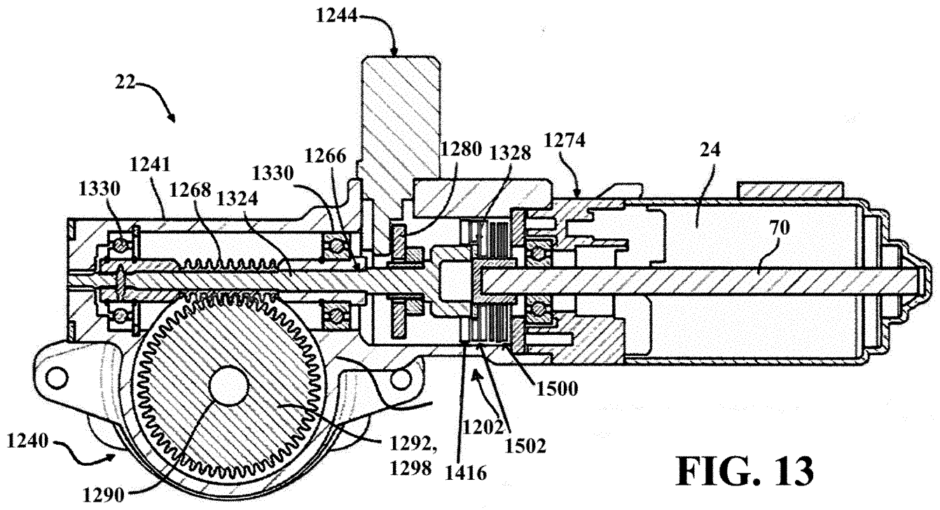

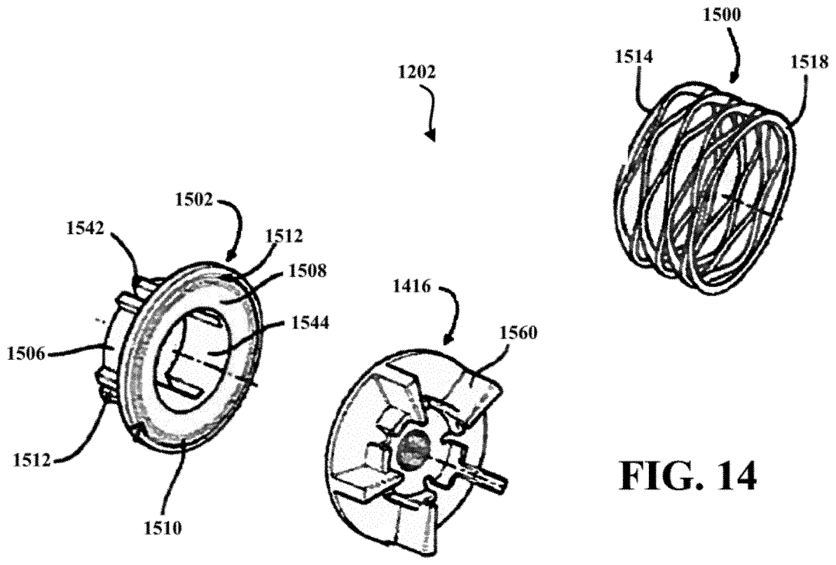

Now referring to FIGS. 13 and 14, there is shown an example of a modified power actuator unit 22 in which a brake mechanism takes the form of a constant friction device 1202 (in addition to or in place of clutch and brake assembly 28). FIG. 13 illustrates a cut-away view of the modified powered actuator 22 according to aspects of the disclosure. Specifically, the plane of the cut-away view shown in FIG. 13 extends through the driven shaft 1266. As shown in FIG. 13, the powered actuator unit 22 includes a gearbox 1240 within a gearbox housing 1241. A motor bracket 1274 is attached to an axial end of the electric motor 24. The driven shaft 1266 comprises a gearbox input shaft 1324 that is coupled to the motor shaft 70 of the electric motor 24 via a coupling 1328. The coupling 1328 may be a fixed coupling, such as a splined connection, causing the gearbox input shaft 1324 to rotate with the motor shaft 70. In some embodiments, the coupling 1328 may be a flex coupling, allowing some degree of relative rotation between the gearbox input shaft 1324 and the motor shaft 70. A set of input bearings 1330 holds the gearbox input shaft 1324 on either side of the worm gear 1268. Either or both of the input bearings 1330 may be any type of bearing, such as a ball bearing, a roller bearing, etc.

In some embodiments, and as shown in FIG. 13, the torque tube 1292 and the worm wheel 1298 are formed as an integrated unit, with gear teeth formed on an outer perimeter, and with the lead nut 1290 formed on an inner bore. In some embodiments, the torque tube 1292 and the worm wheel 1298 are formed as an integrated unit, and the lead nut 1290 is a separate piece that is fixed to rotate therewith. The lead nut 1290 is disposed around and in threaded engagement with the extensible member 25.

The powered actuator unit 22 shown in FIG. 13 includes a high-resolution position sensor 1244 including a magnet wheel 1280 that is coupled to rotate with the driven shaft 1266 and which includes a plurality of permanent magnets.

The constant friction device 1202 of the modified power actuator unit 22 is shown as a contact ring 1502, sprag ring 1416, and wave spring 1500 for applying a biased constant friction force or resistance to resist rotation of the motor shaft 70. For example the constant friction device 1202 may introduce a constant friction resistance, such as of 40 kilonewtons (kN), which may be applied to the motor shaft 70. Such constant friction resistance is applied to resist motion of the door 12 between open and closed positions at a constant amount. The constant friction resistance (e.g., 40 kN) is selected to allow the door 12 to be held in an open position without the use of power to resist wind gusts and gravity until a certain amount, but allows a user to manually overcome the friction force and move the door. Other values of the constant friction resistance may be selected other than 40 kN. Generally the constant friction device 1202 may resist movement of a member of the power actuator unit 22 upstream from a gearing device (e.g., gearbox 1240), such that the friction force by the constant friction device 1202 is multiplied through the gearing device, such that the resistance to the door motion of the constant friction device 1202 is increased at the door side to resist door motion.

FIG. 14 shows the wave spring 1500, the contact ring 1502, and the sprag ring 1416. The sprag ring 1416 includes a plurality (e.g., five (5)) of equally-spaced drive lugs 1560 configured to be received by the contact ring 1502 so as to establish a drive interface. The contact ring 1502 includes a rim segment 1506 including a plurality (e.g., five (5)) anti-rotation features, shown as grooves 1542, arranged and configured to each accept and retain a corresponding one of the plurality of equally-spaced drive lugs 1560 of sprag ring 1416. Thus, contact ring 1502 is held by the sprag ring 1416 via this anti-rotation feature and preventing relative rotational motion between the contact ring 1502 and the sprag ring 1416, though permitting relative axial movement therebetween. Accordingly, rim segment 1506 of contact ring 1502 has an inner surface 1544 sized (enlarged to provide a slightly loose-fit) and configured to engage an outer surface of motor shaft 70. Contact ring 1502 also includes a radial pressure plate segment 1508 extending radially outwardly from rim segment 1506 and having an annular engagement flange 1510 extending axially outwardly from rim segment 1506 to define a friction contact surface 1512 to abut the wave spring 1500, So a first end 1514 of the wave spring 1500 abuts the friction contact surface 1512 of contact ring 1502 and a second end 1518 engages a portion of motor bracket 1274. Wave spring 1500 is compressed when installed to apply a normal force on contact ring 1502. Thus, the wave spring 1500 urges the contact ring 1502 into engagement with the sprag ring 1416; however rotational slip may occur between the second end 1518 of the wave spring 1500 and the friction contact surface 1512 of contact ring 1502. Other types of spring (Belleville, helical, plate, etc.) can be used in substitution for wave spring 1500.

Constant friction device 1202 is configured to provide a no-power door hold function. In other words, the brake mechanism 28, 1202 or constant friction device 1202 is adapted to apply a braking force to the extensible actuation member 25 for resisting motion of the door 12 (e.g., through the motor shaft 70 being coupled to driven shaft 1266 and consequently worm wheel 1298, which is connected to lead nut 1290 disposed around and in threaded engagement with the extensible actuation member 25). However, during motion of the door 12, the constant friction device 1202 also introduces friction in a slip state to resist door motion due to the power actuator 22. As a result, the door actuation system 20, operating in either a power assist mode or an automatic mode may be configured to compensate for the constant friction introduced in the power actuator unit 22. So, because the brake mechanism 28, 1202 is operable in the slip state to allow the door 12 to be moved by the user in order for the electronic control module 50′, 52 to detect the detected motion to activate the power assist mode of the electronic control module 50′, 52. Once the electronic control module 50′, 52 has detected the detected motion and has activate the power assist mode of the electronic control module 50′, 52, the brake mechanism 28, 1202 may continue to operate in the slip state to allow the door 12 to be moved by the door actuation system 20. In other words, the braking resistance against door movement provided by brake mechanism 28, 1202 is present when the door 12 is both in motion, and when the door is not in motion 12. The electronic control module 50′, 52 controls the electric motor 24 in the power assist mode in response to a detected motion of the door 12 by a user moving the door 12 to overcome the braking force. Put another way, the brake mechanism 28, 1202 is configured to apply a friction force during motion of the door 12 and while the door 12 is not in motion. The electronic control module 50′, 52 is configured to move the door 12 by controlling the motor force to negate the braking force during the motion of the door 12. In other words, the electronic control module 50′, 52 is configured to increase the motor force outputted to not only move the door, by also to overcome the braking force of the constant friction 1202 device during the motion of the door 12 so that the door motion is not changed compared to a configuration without the constant friction device 1202. For example, if such an adaptation of the electronic control module 50′, 52 were not made in light of the influence of the constant friction device 1202 resisting the door motion, the door may move at a slower rate as compared to if the constant friction device 1202 was not included in the configuration. As a result, when the motor is de-energized, the constant friction device 1202 can hold the door at such a position, without the requirement of having to energize the motor which may possibly lead to a depletion of the motor's source of power, such as a vehicle battery.

For example, the memory device 92 of the '601 patent application may be further adapted to store the friction level or constant friction resistance (e.g., 40 kN) as part of the closure member parameters 106 used by the system 20 for assisting the user 75 with moving the closure member 12, further to the parameters such as the closure member friction 106d, in order to compensate for constant friction device 1202 of the actuator 22. As a result, the actuator output force is increased to overcome the friction of the constant friction device 1202 during motion of the door 12, such that a user does not have to introduce additional user force to move the door 12. Once power has been removed from the door actuator 22, for example after the door 12 has moved to a partially opened door position after a powerassist or automatic mode operation, the constant friction resistance of the constant friction device 1202 will act to hold the door 12 without the use of power.

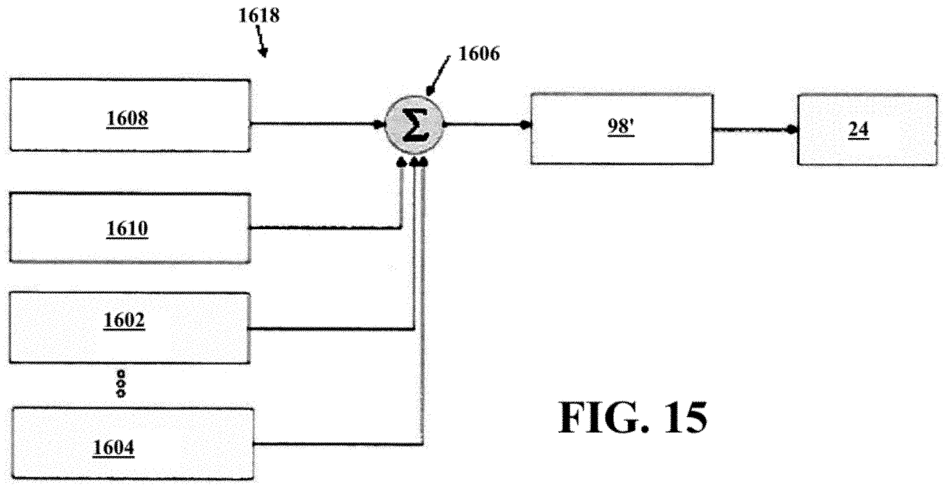

As shown in FIG. 15, there is illustrated an example of the electronic control module 50′, 52 determining if any auxiliary door systems are active and updating the relevant torque moments to include a relevant torque moments 1602 related to an auxiliary door system. For example, the electronic control module 50′, 52 may determine if a door presenter is activated to also assist with moving the door 12, and include the relevant torque moment(s) 1602 of the auxiliary system(s) updated in real time based on a door angle of the door 12 for inclusion as part of a superposition calculation function 1618. Such auxiliary door systems may be selectively activated for acting on the door 12 for a portion of the door angle. Other door systems or influences on movement of the door 12 have related relevant torque moments 1604 that may be included or removed by the electronic control module 50′, 52 when performing the superposition function 1618, such as if a separate door check mechanism is acting on the door 12, if the clutch and brake assembly 28 and/or constant friction device 1202 is acting on the door 12, if another door is interacting with the door 12 such as in the case of a B-pillarless door system, as examples and without limitation. Therefore, the electronic control module 50′, 52 may execute a summation 1606 of the net torque response 1608, the compensating torque 1610, the relevant torque moment(s) 1602 and proceed to calculate a force command 88′ using a force command generator 98′ to be supplied to the motor 24. Thus, the electronic control module 50′, 52 may be modified for example by introducing a friction mechanism value corresponding to the friction force or resistance introduced by the constant friction device 1202 of the actuator 22 by updating the torque moments 1604 of FIG. 15 with the constant friction resistance or friction mechanism value.

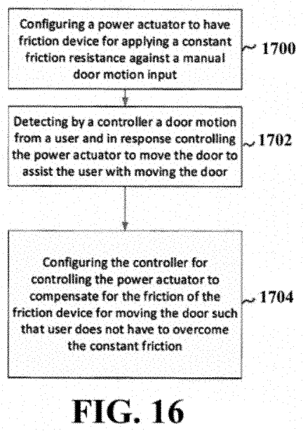

FIG. 16 is a flow diagram illustrating another method of operating a power-operated door or power door system 20. The method includes the step of 1700 configuring a power actuator 22 to have a constant friction device 1202 for applying a constant friction resistance against a manual door motion input. The method continues with the step of 1702 detecting by an electronic control module 50′, 52 motion of a door 12 from a user and in response controlling the power actuator 22 to move the door 12 to assist the user with moving the door 12. The next step of the method is 1704 configuring the electronic control module 50′, 52 for controlling the power actuator 22 to compensate for the friction of the constant friction device 1202 for moving the door 12 such that the user does not have to overcome the constant friction resistance.

The brake mechanism 28, 1202 may be provided at other operation positions between the door and the vehicle body other than within a power door actuator, such as be formed as part of a door check device, as part of a hinge, or a counterbalance or dampener device, as but non-limiting examples.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A power drive mechanism for pivoting a vehicle swing door relative to a vehicle body between a closed position and an open position, the power drive mechanism comprising:
an electric motor having a de-energized state and an energized state;
a housing having an inner wall bounding a cavity;
an extensible actuation member linearly moveable relative to the housing, wherein linear movement of the extensible actuation member in a first direction causes movement of the vehicle swing door in an opening direction from the closed position toward the open position and linear movement of the extensible actuation member in a second direction causes movement of the vehicle swing door in a closing direction from the open position toward the closed position; and
a clutch and brake assembly disposed in the cavity of the housing, the clutch and brake assembly operably connecting the electric motor to the extensible actuation member and being moveable from a disengaged state, whereat the extensible actuation member is inhibited from moving relative to the housing, to an engaged state, whereat the extensible actuation member is free to move relative to the housing,
wherein the clutch and brake assembly moves from the disengaged state to the engaged state in response to the electric motor being switched from the de-energized state to the energized state.

2. The power drive mechanism of claim 1, wherein the clutch and brake assembly moves from the engaged state to the disengaged state in response to the electric motor being switched from the energized state to the de-energized state.

3. The power drive mechanism of claim 2, wherein the clutch and brake assembly includes a spring member disposed in the cavity of the housing, the spring member being biased to a radially expanded state when the electric motor is in the de-energized state, whereat the spring member is in locked engagement with the inner wall of the housing and the extensible actuation member is inhibited from moving in the second direction to inhibit the vehicle swing door from moving from the open position toward or away from the closed position.

4. The power drive mechanism of claim 3, wherein the spring member is wound against the bias to a radially contracted state into operable engagement with a driven member operably coupled to the extensible actuation member when the electric motor is in the energized state, whereat the spring member is spaced radially inwardly from the inner wall and the extensible actuation member is movable in the first direction to move the vehicle swing door from the closed position toward the open position.

5. The power drive mechanism of claim 4, wherein while the vehicle swing door is in the open position and while the electric motor is in the de-energized state, movement of the extensible actuation member in the second direction causes the driven member, operably coupled to the extensible actuation member, to engage the spring member and increase the bias of the spring member toward the radially expanded state to increase the locked engagement of the spring member with the inner wall to inhibit the vehicle swing door from moving in the closing direction toward the closed position.

6. The power drive mechanism of claim 5, wherein the clutch and brake assembly includes a drive member having a generally cylindrical outer wall region, the spring member being disposed about the generally cylindrical outer wall region in radially spaced relation therefrom while in the radially expanded state and in radially constricted engagement therewith while in the radially contracted state.

7. The power drive mechanism of claim 6, wherein the spring member is a coil spring.

8. The power drive mechanism of claim 6, wherein the drive member is a clutch plate operably fixed to an output member of the electric motor and the driven member is a fork operably fixed to an input member coupled to the extensible actuation member, the fork being driven by the spring member in response to the spring member being radially constricted by the clutch plate, whereat the extensible actuation member is driven in the first direction by the input member.

9. The power drive mechanism of claim 8, wherein the input member is a worm configured in meshed engagement with a worm gear of a leadscrew of the extensible actuation member.

10. The power drive mechanism of claim 9, wherein the clutch and brake assembly comprises a braking state wherein the extensible actuation member is inhibited from moving in the second direction to inhibit the vehicle swing door from moving from the open position toward or away from the closed position in response to a manual force below a predetermined threshold applied to the swing door and an override state wherein the extensible actuation member is allowed to move in the second direction to allow the vehicle swing door to move from the open position toward or away from the closed position in response to a manual force above the predetermined threshold applied to the swing door.

11. A power door system comprising:
an electric motor for operating an extensible actuation member to move a door between open and closed positions;
a brake mechanism adapted to apply a braking force to the extensible actuation member for resisting motion of the door; and
an electronic control module for controlling the electric motor in a power assist mode in response to a detected motion of the door by a user moving the door to overcome the braking force, wherein the brake mechanism is operable in a slip state to allow the door to be moved by the user in order for the electronic control module, to detect the detected motion to activate the power assist mode of the electronic control module.

12. The power door system of claim 11, wherein the brake mechanism is a constant friction device including a contact ring coupled to a motor shaft of the electric motor and engaging a sprag ring, the contact ring abutting a wave spring compressed against the electric motor for applying the braking force in a constant manner to resist rotation of the motor shaft.

13. The power door system of claim 12, wherein sprag ring includes a plurality of equally-spaced drive lugs and the contact ring includes a rim segment including a plurality of anti-rotation features arranged and configured to each accept and retain a corresponding one of the plurality of equally-spaced drive lugs of sprag ring to prevent relative rotational motion between the contact ring and the sprag ring while permitting relative axial movement therebetween, the rim segment of the contact ring has an inner surface sized and configured to engage an outer surface of motor shaft, the contact ring includes a radial pressure plate segment extending radially outwardly from rim segment and having an annular engagement flange extending axially outwardly from rim segment to define a friction contact surface to abut the wave spring.

14. The power door system of claim 11, wherein the brake mechanism a clutch and brake assembly for applying a friction resistance against a manual door motion input in an engaged state and removing the friction resistance in a disengaged state.

15. A method of operating a power closure member actuation system comprising the steps of:
configuring a power actuator to have a brake mechanism adapted to apply a braking force to an extensible actuation member of the power actuator for resisting motion of a door;
detecting motion of the door by a user; and
controlling an electric motor in a power assist mode using an electronic control module in response to a detected motion of the door by the user moving the door to overcome the braking force, wherein the brake mechanism is operable in a slip state to allow the door to be moved by the user in order for the electronic control module to detect the detected motion to activate the power assist mode of the electronic control module.

16. The method of claim 15, wherein the brake mechanism is a clutch and brake assembly for applying a friction resistance against a manual door motion input in an engaged state and removing the friction resistance in a disengaged state, the method further comprising the steps of:
detecting motion of the door by the user when the clutch and brake assembly is in a slip state; and
configuring the electronic control module for controlling the electric motor of the power actuator to move the door in response to detecting motion of the door, wherein the control of the electric motor causes the clutch and brake assembly to shift from the engaged state to the disengaged state.

17. The method of claim 15, wherein the brake mechanism is a clutch and brake assembly and the power actuator includes an electric motor operably connected to the extensible actuation member and having a de-energized state and an energized state and the extensible actuation member is linearly moveable in a first direction to cause movement of the door in an opening direction and in a second direction to cause movement of the door in a closing direction, the method further including the steps of:
configuring the clutch and brake assembly to move the extensible actuation member in the first direction while the clutch and brake assembly is in an engaged state and to inhibit the extensible actuation member from moving in the second direction while the clutch and brake assembly is in a disengaged state; and
configuring the clutch and brake assembly to become mechanically actuated and move to the disengaged state when the electric motor is changed from the energized state to the de-energized state.

18. The method of claim 17, wherein the clutch and brake assembly couples a rotatable input with a rotatable output and includes a spring member disposed in a cavity of a housing, the spring member is biased to a radially expanded state in locked engagement with an inner wall of the housing, the method further includes the steps of:
rotating the rotatable input to cause the spring member to radially constrict and transition the spring member from a locked engagement with the inner wall to an unlocked engagement from the inner wall to allow the rotatable output to rotate conjointly in conjunction with the rotatable input; and
stopping the rotating of the rotatable input to cause the spring member to return to the radially expanded state and transition the spring member from the unlocked engagement to the locked engagement with the inner wall to prevent rotation of the rotatable output relative to the housing.

19. The method of claim 18, wherein the step of rotating the rotatable input can include the step of energizing the electric motor and the step of stopping the rotating of the rotatable input can include the step of de-energizing the electric motor.

20. The method of claim 15, wherein the brake mechanism is a constant friction device for applying a constant friction resistance against a manual door motion input, the method further comprising the steps of:
detecting by the electronic control module motion of the door from the user and in response controlling the power actuator to move the door to assist the user with moving the door; and
configuring the electronic control module for controlling the power actuator to compensate for the constant friction resistance of the constant friction device for moving the door such that the user does not have to overcome the constant friction resistance.
